(19) United States
(12) Patent Application Publication
(10) Pub. No.: US 2004/0255324 A1
(43) Pub. Date: Dec. 16, 2004

(54) Media playback system for a personal computer

(76) Inventor: Kuo Y. Lung, Keelung (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/744,510

(22) Filed: Dec. 22, 2003

(30) Foreign Application Priority Data
Dec. 27, 2002 (TW) 091221346

(51) Int. Cl. G06F 3/00

(52) U.S. Cl. 725/37

(57) ABSTRACT

A media playback system integrated in a personal computer allows the playing of media data, such as audio and/or video data, without having to boot the operating system of the personal computer or waste electrical power by initializing the chips or chipsets in the computer with the BIOS. A media input unit loads media data from a media source, such as a CD or DVD drive of the computer. A control interface receives a user command to play the media and generates an instruction received by a media playback unit. Responsive to the instruction, the media playback unit receives media data from the media input unit, decodes the media data, and sends it to a playback unit to be played.

### CROSS REFERENCE TO RELATED APPLICATIONS

This application claims the right of priority based on Taiwan application serial no. 091221346, filed on Dec. 27, 2002, which is herein incorporated in its entirety by reference.

### BACKGROUND

1. Field of the Invention

The invention relates generally to media playback systems, and in particular to media playback systems incorporated in personal computers.

2. Background of the Invention

As computing technology develops, personal computers feature increasingly more powerful processing capabilities. In addition to traditional computing tasks, the more powerful processors are designed to process multimedia data, for example video and sound data stored in formats such as CD, VCD and DVD. Existing personal computing products that offer multimedia capabilities include those described in Taiwanese Patent No. 199,168, which discloses a personal computer that plays music from a CD in a pause mode. In such a device, however, the computer can only play music from the CD while the computer is in the pause mode.

Another personal computer system having multimedia capabilities is described in Taiwanese Patent No. 303,437, which discloses an entertainment system for portable personal computers. This entertainment system includes television and AM/FM radio receivers and an internal antenna that picks up and feeds television and radio signals to the corresponding receivers. Under control of software running on the computer's microprocessor, audio signals are sent to a built-in audio processor and video signals are sent to a built-in video processor. However, this system can operate only when the portable personal computer is in a powered down mode.

In another type of system, described in Taiwanese Patent No. 481,764, a personal computer plays music from a CD in a powered down mode. In this system, a built-in microprocessor reads length data of audio tracks on the CD in a normal operation mode. The microprocessor then sets a wake time by adding this length to reference time provided by an internal clock. When the personal computer is in the powered down mode, the microprocessor waits for a time period defined by the wake time, after which it is awoken to operate again in the normal mode. Like the system described above, however, the personal computer is only able to play music from the CD while it is in the powered down mode.

In yet another system, described in Taiwanese Patent No. 504,641, a personal computer plays multimedia data in a “bootstrap” mode without having to start the operating system. The system includes software stored in the BIOS that initializes associated chips or chipsets after powering on the computer. The software then reads the names of the files stored on the CD, VCD or DVD media using ATAPI commands, labels and sends these file names to a microcontroller, and allows the CPU to work in a “stop clock” mode. The microcontroller commands the CPU to decode and send the files to a player device that does not require starting the operating system. However, the associated chips or chipsets must be initialized by the BIOS after powering on, which consumes power.

As described above, existing technology does not enable a personal computer to start an audio or video playback device without starting its operating system or initializing associated chips or chipsets with the BIOS. Personal computer users need a video playback device that allows users to play media without having to boot their operating systems or waste electrical power by initializing the chips or chipsets in the computer with the BIOS.

### SUMMARY OF THE INVENTION

Accordingly, the present invention includes a media playback system that allows users to play media without having to boot their operating systems or waste electrical power by initializing the chips or chipsets in the computer with the BIOS. As used herein, media includes audio, video, and combinations thereof.

In one embodiment of the invention, a media playback system includes a media input unit that loads media data from a media source, such as a CD or DVD drive of the computer. A control interface receives a user command to play the media and generates an instruction received by a media playback unit. Responsive to the instruction, the media playback unit receives media data from the media input unit and decodes the media data. The media playback unit sends the decoded media to a media output unit, which plays the decoded media data.

The media playback system may be activated by a number of mechanisms. For example, the system may include one or more buttons on the front panel of a computer chassis, a remote control, or a remote networking client coupled to the playback system over a network.

### BRIEF DESCRIPTION OF THE DRAWINGS

FIG. 1 is a block diagram the media playback system in accordance with an embodiment of the invention.

FIG. 2 shows a personal computer having an integrated media playback system, in accordance with one embodiment of the invention.

### DETAILED DESCRIPTION OF THE PREFERRED EMBODIMENTS

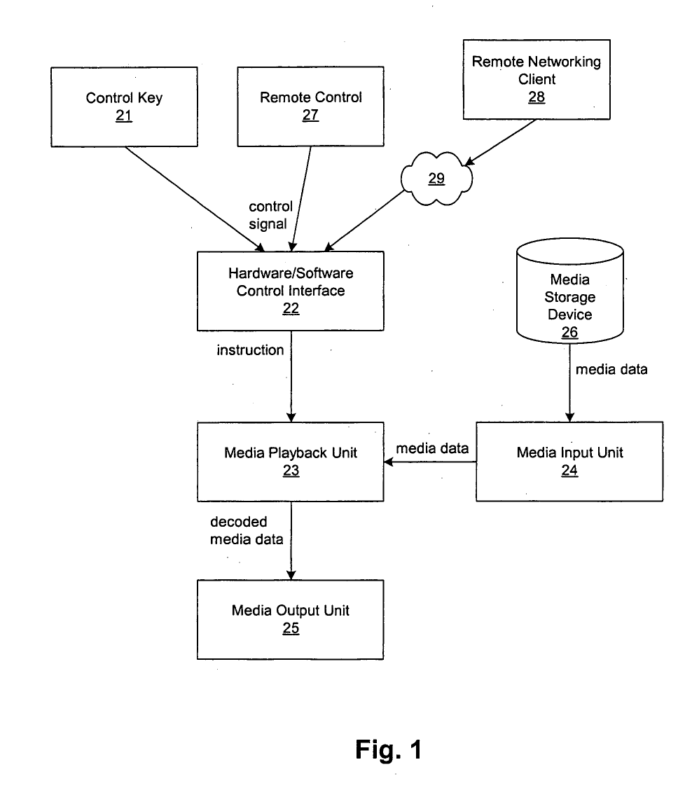

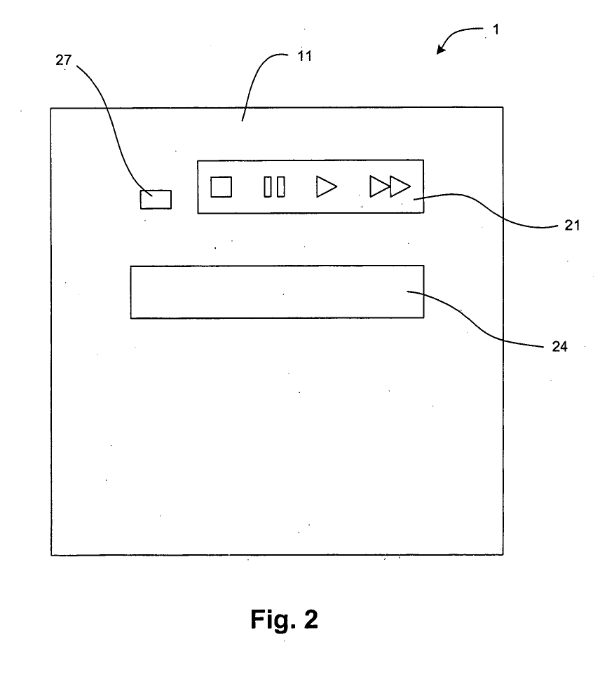

The block diagram in FIG. 1 shows the operation of a media playback system in accordance with an embodiment of the invention. The media playback system is incorporated into a personal computer system. In response to a user selection, the system causes media to be played by the personal computer system 1, for example a video shown on a computer screen and/or audio played by an attached speaker system. FIG. 2 illustrates a physical embodiment of the personal computer 1 and media playback system in accordance with one embodiment of the invention.

A user can select and play media using the system with a variety of user input mechanisms. In one embodiment, the media playback system includes one or more control keys 21 that can accept a user selection. The control keys 21 may include a plurality of buttons to control the playback of a media selection. In the example of FIG. 2, the control keys 21 include stop, pause, play, and skip buttons. In addition to or alternative to the control keys 21, the playback system may include a remote control 27 to allow the user to make selections from a distance. As FIG. 2 illustrates, a front panel 11 of the personal computer 1 includes the control keys 21 and the remote control interface 27 for the media playback system.

In another embodiment, the user makes media playback selections on a remote networking client device 28, such as another computer, a personal digital assistant (PDA), a cellular phone, or a similar device. The remote networking client 28 communicates the selection to the playback system over a network 29. The remote networking client 28 may be coupled to the playback system through a network card on the motherboard of the personal computer 1.

When the user makes a selection using the control keys 21, the remote control 27, or the remote networking client 28, that control device sends a control signal to the hardware/software control interface 22. In one embodiment, the hardware/software control interface 22 resides in the BIOS of the personal computer 1. Alternatively, the hardware/software control interface may reside in other peripheral storage media, such as a disk drive or static memory module. The hardware/software control interface 22 receives and decodes the control signal received from the control key 21, remote control 27, or remote networking client 28. Using associated control instructions, e.g., in the BIOS, the hardware/software control interface 22 generates an instruction based on the control signal. The hardware/software control interface 22 communicates this instruction to a media playback unit 23. A media playback unit 23, coupled to the hardware/software control interface 22, accepts the instruction from the control interface 22 and performs related operations. Such operations may include start or stop playing the media and skipping forward and backward in the media. The media playback unit may be implemented in software that resides in static memory (such as flash memory) or on a storage medium such as a floppy, hard, or optical disk drive.

When the media playback unit 23 requires media data to satisfy the instruction, the playback unit 23 sends a command to a media input unit 24 to retrieve the required media data. The media data is located on a media storage device 26, such as a CD or DVD drive of the personal computer 1. Alternatively, the media data may be obtained from any suitable source of media, including a remote storage devices communicatively coupled to the media input unit. The media input unit 24, coupled to the media playback unit 23, then feeds the media data to the playback unit 23 for decoding. A media output unit 25 is coupled to the media playback unit 23 to receive the decoded media data and play the media. The media output unit 25 may include a set of speakers, a display, an interface to drive external speakers or an external display, and/or any other suitable device for playing the selected media.

In one example to illustrate the operation of an embodiment of the media playback system, the personal computer 1 is powered on. The user then presses the control key 21 or activates the remote control 27 or the remote networking client 28 to start the media playback system before the operating system of the computer 1 has started. This causes a control signal to be sent to the hardware/software control interface 22, which decodes the control signal and sends a start instruction to the media playback unit 23. The media playback unit 23 obtains the media data that the media input unit 24 loads from the media storage device 26. The media playback unit 23 decodes the media data and sends it to the media output unit 25. In this way, the user can start the media playback system by pressing a control key when the personal computer is powered on without having to boot the operating system.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. It is therefore intended that the scope of the invention be limited not by this detailed description, but rather by the claims appended hereto.

I claim:

1. A media playback system integrated in a personal computer for playing media data, the media playback system comprising:
a media input unit for loading media data from a media source;
a control interface for receiving a user command to play media, the control interface generating an instruction in response to receiving the user command;
a media playback unit coupled to receive the instruction from the control interface, responsive to the instruction the media playback unit receives media data from the media input unit and decodes the media data; and
a media output unit coupled to the media playback unit for receiving and playing the decoded media data
wherein the media playback system can play the media data without requiring the personal computer to boot an operating system or initialize a chipsets in the personal computer with a BIOS.

2. The media playback system of claim 1, wherein the media input unit retrieves audio and video data from a DVD drive.

3. The media playback system of claim 1, wherein the media input unit retrieves audio data from a CD drive.

4. The media playback system of claim 1, further comprising:
a control key located on a front panel of the personal computer, the control key coupled to the control interface for communicating the user command thereto.

5. The media playback system of claim 1, wherein the control interface is coupled to a remote control system for receiving the user command.

6. The media playback system of claim 1, wherein the control interface is communicatively coupled to a remote client over a network and receives the user command from the client.

7. The media playback system of claim 1, wherein the control interface resides in a flash memory of the computer.

8. The media playback system of claim 1, wherein the control interface resides in a peripheral storage media of the computer.

9. The media playback system of claim 1, wherein the media playback unit includes multimedia playback software.
